(19) United States
(12) Patent Application Publication
(10) Pub. No.: US 2009/0164986 A1
(43) Pub. Date: Jun. 25, 2009

(54) Extended package scheme to support application program downloading, and system and method for application porogram service using the same

(76) Inventors: Heekyung Lee, Daejon (KR); Gun Bang, Daejeon (KR); Jung-Won Kang, Seoul (KR); Jae-Gon Kim, Daejeon (KR); Jin-Soo Choi, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/658,305

(22) PCT Filed: Jul. 23, 2005
(86) PCT No.: PCT/KR05/02389

§ 371 Date: Jan. 23, 2007

Related U.S. Application Data
(60) Provisional application No. 60/590,691, filed on Jul. 23, 2004.
(60) Provisional application No. 60/610,999, filed on Sep. 17, 2004.
(60) Provisional application No. 60/628,380, filed on Nov. 15, 2004.

(51) Int. Cl. G06F 9/44; G06F 17/30

(52) U.S. Cl. 717/168; 707/102; 707/E17.044

(57) ABSTRACT

Provided is a package scheme to support application program downloading and a method and a system for an application program download service using the same in a system such as a TV-Anytime system. A method for forming a package capable of supporting application program downloading includes the steps of: a) generating metadata on general information of the application program including type information of the application program; b) generating metadata on detailed information of the application program including version information of the application program; c) generating metadata on usage environment of a terminal to which the application program is applied; and d) generating a package including the application program and all the metadata.

### TECHNICAL FIELD

The present invention relates to a package scheme to support application program downloading; and, more particularly, to an extended package scheme to support application program downloading, and a method and a system for an application program download service using the same in a system such as a TV-Anytime system.

### BACKGROUND ART

Recently, discussion on ObjectDescriptionMetadata in a TV-Anytime forum is continued. The ObjectDescriptionMetadata is necessary information for exact consumption of the object according to its intended purpose.

Also, description on an application program and a package scheme for supporting are very important discussion subjects. Herein, the application program means an object operated in a user terminal, e.g., a set-top box supporting the TV-Anytime and PDR, and performing a specific function.

The application program is very sensitive to a usage environment of a terminal. That is, since when a usage environment of a terminal is not proper to operation of an application program, the application program cannot be consumed in a terminal, description on a usage environment in which the application program can be consumed and description on usage method are very important. For example, when an application program is a driver for updating a terminal, manufacturer information and model information of hardware are the most important usage environment conditions.

Therefore, exact description on an application program, description on user environment information that an application can be consumed, and a package scheme that can provide the application program is required for effective and successful download of an application program in a terminal.

### DISCLOSURE

### Technical Problem

It is, therefore, an object of the present invention to provide a package scheme that can support application program downloading.

It is another object of the present invention to provide a method and a system for an application program service using the extended package scheme to support application program downloading.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided a method for firming a package capable of supporting application program downloading, including the steps of: a) generating metadata on general information of the application program including type information of the application program; b) generating metadata on detailed information of the application program including version information of the application program; c) generating metadata on usage environment of a terminal to which the application program is applied; and d) generating a package including the application program and all the abovementioned metadata.

In accordance with another aspect of the present invention, there is provided a package capable of supporting application program downloading, including: a metadata description block related to general information of the application program; a metadata description block related to detailed information of the application program; and a metadata description block related to a usage environment of a terminal that the application program is applied.

In accordance with another aspect of the present invention, there is provided a method for acquiring an application program in a user terminal, including the steps of: a) receiving an extended package including metadata on general information, detailed information and a usage environment; and b) acquiring an application program which fits to a user terminal environment by using the extended package.

In accordance with another aspect of the present invention, there is provided a user terminal for acquiring an application program, including: an extended package receiving block for receiving an extended package with respect to an application program to be acquired; an object information extracting block for extracting object information of the application program from the received extended package; and a position information acquiring block for acquiring position information of the application program by using the object information.

In accordance with another aspect of the present invention, there is provided a system for an application program download service, including: an extended package providing block for providing an extended package, which includes metadata on general information, detailed information and a usage environment, to a user terminal; and a user terminal for acquiring a predetermined application program which fits to usage environment of a user terminal and consuming and using the application program by.

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on the prior art may blur the points of the present invention, the detailed description will not be provided herein. The preferred embodiments of the present invention will be described in detail hereinafter with reference to the attached drawings.

### ADVANTAGEOUS EFFECTS

As described above, the present invention provides an application metadata structure that makes an application program consumed or used in a terminal according to a usage purpose, and exactly provide an application program download service of by using a package extended by including the application metadata structure.

### DESCRIPTION OF DRAWINGS

The above and other objects and features of the present invention will become apparent from the following description of the preferred embodiments given in conjunction with the accompanying drawings, in which:

FIG. 1 is a schema on general information of an application in accordance with an embodiment of the present invention;

FIG. 2 is an XML schema defining a schema structure shown in FIG. 1;

FIG. 3 is a schema on detailed information of an application in accordance with the present invention;

FIG. 4 is an XML schema defining a schema structure shown in FIG. 3;

FIG. 5 is a diagram showing a high-level structure of an application program in accordance with an embodiment of the present invention;

FIG. 6 is an exemplary diagram showing a category structure of the Consumption shown in FIG. 5;

FIG. 7 is an exemplary diagram showing a category structure of the Management shown in FIG. 5;

FIG. 8 is a schema showing one example of extended UED means in accordance with an embodiment of the present invention;

FIG. 9 is an XML schema defining a schema structure shown in FIG. 8; and

FIG. 10 is a block diagram showing a structure of an application program service system.

### BEST MODE FOR THE INVENTION

In the claims of the present specification, an element expressed as a means for performing a function described in the detailed description is intended to include all methods for performing the function including all formats of software, such as combinations of circuits for performing the intended function, firmware/microcode and the like. To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

An extended package scheme for supporting application program downloading will be described first, and then a system and a method for an application program service using the same will be described hereinafter.

<Extended Package Scheme>

A package scheme suggested in the present invention can be applied to a system for supporting a two-way service between a server and a client, and TV-Anytime service will be described hereinafter as an example.

A package scheme including metadata for describing an application program and metadata for Usage Environment Description (UED) is required for an exact download of an application program and an exact operation in a proper user environment. Hereinafter, it is noted that application can be simply called as an application.

A. Application Description Metadata

As described in Table 1, metadata for describing an application program includes metadata on general information of an application and metadata on detailed information.

TABLE 1

| | Detailed Information |
|---|---|
| General Information of Application | of application |
| title | whether |
| media title | Pay/free application |
| short title | whether deletion |
| synopsis | program is provided |
| recommendation information | |
| keyword | |
| genre parental guidance | |
| language | |
| actor | |
| award related contents | |
| production date | |
| production location | |

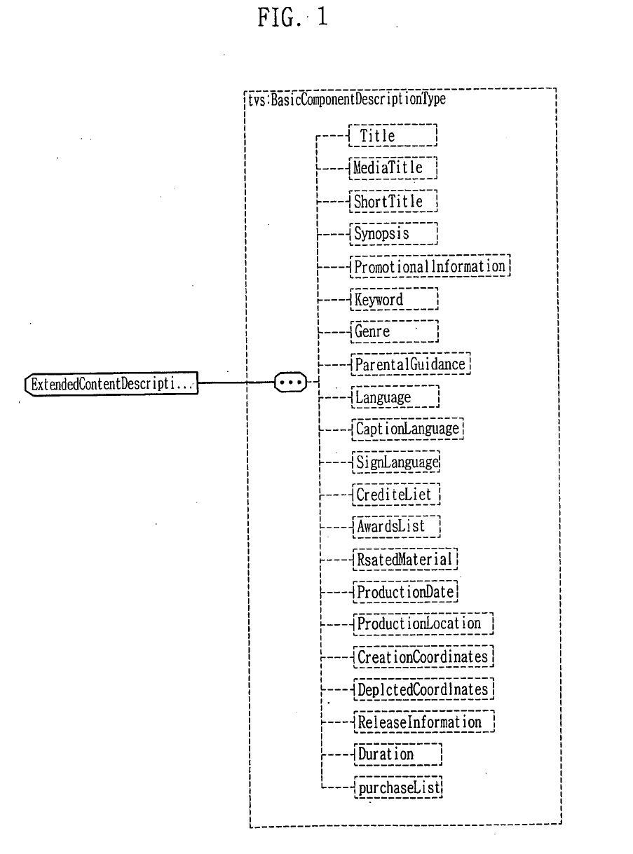

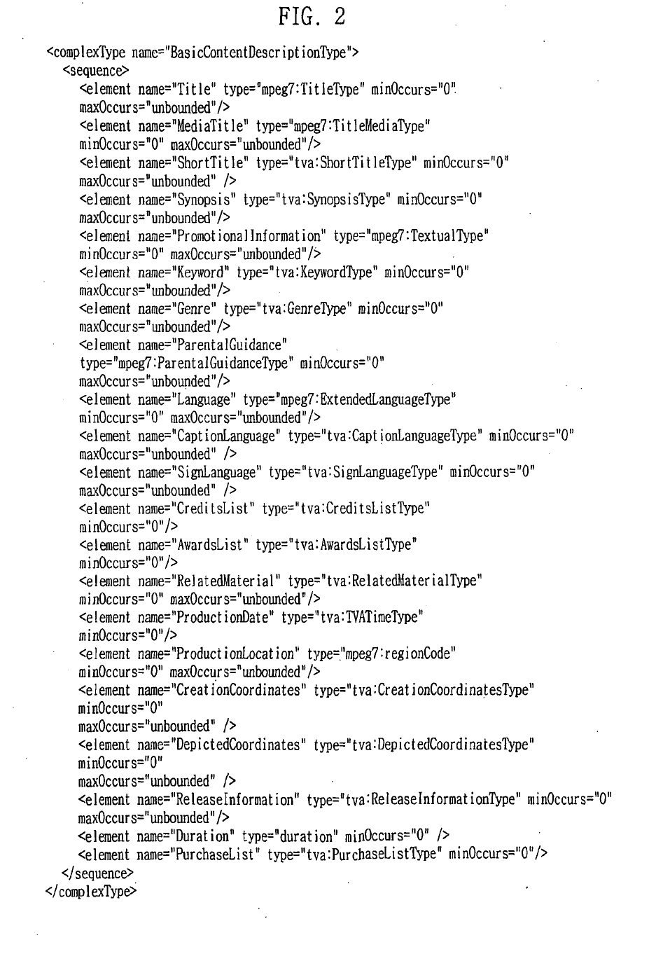

FIGS. 1 and 2 are schemas on general information of an application and FIG. 2 is an XML schema defining a schema structure shown in FIG. 1.

Referring to FIG. 1, BasicContentDescriptionType for describing general information of an application includes metadata for describing common characteristics of all contents objects such as a video, an audio and Html. A function definition of each element included in the BasicContentDescriptionType is as described in the following Table 2.

TABLE 2

| Name | Definition |
|---|---|
| BasicContentDescriptionType | A complex type that defines standard programme |
| | description elements. |
| Title | A title of the programme. A programme can have multiple |
| | titles, e.g. In different languages. Defined as an MPEG-7 |
| | datatype, TitleType (see clause 9.2.2 in |
| | ISO/IEC 15938-5 [2] for a detailed specification). |
| MediaTitle | A media asset (e.g. Image) that can be used as a “title” |
| | for a programme. Content that is not part of the original |
| | programme can be specified and used as a (promotional) |
| | AV title. Defined as an MPEG-7 datatype, |
| | TitleMediaType (see clause 9.2.2 in |
| | ISO/IEC 15938-5 [2] for a detailed specification). |
| ShortTitle | A shortened version of the programme title that defines |
| | how the title should be truncated for presentation |
| | purposes. |
| Synopsis | A textual description of the programme. |
| PromotionalInformation | A textual description containing promotional information. |
| Keyword | A list of keywords for the programme. A keyword can be a |
| | single word or an entire phrase made up of multiple |
| | words. Defined as a TV-Anytime datatype, KeywordType. |
| Genre | A genre for the programme. The thesaurus in annex B |
| | defines the normative TV-Anytime set of genres. |
| ParentalGuidance | A parental rating code for the programme. Defined as an |
| | MPEG-7 datatype, ParentalGuidanceType (see |
| | clause 9.2.3 of ISO/IEC 15938-5 [2] for a detailed |
| | specification). |
| Language | Describes one spoken language for the programme. |
| | There may be more than one spoken language specified |
| | for a programme. |
| CaptionLanguage | Describes one language of the caption information |
| | included with the programme. The type of the caption |
| | information associated with the programme is denoted by |
| | the closed attribute. Closed captions can be turned on or |
| | off by the user, while open captions (or subtitles) are part |
| | of the picture itself and remain visible. |
| SignLanguage | Specifies the sign language provided for the multimedia |
| | content and, optionally, qualifies the use of signing as a |
| | primary language and/or as a translation of the spoken |
| | dialogue. |
| CreditsList | The list of credits (e.g. actors, directors, etc.) for the |
| | programme. |
| AwardsList | The list of awards and/or award nominations for the |
| | programme. |
| RelatedMaterial | A reference to any other material related to a programme. |
| ProductionDate | The date or time period when the programme was |
| | produced, defined as a tva: TVATimeType. |
| ProductionLocation | The country in which the programme was produced. |
| | Defined as an MPEG-7 datatype, regionCode (see |
| | clause 5.6.4 of ISO/IEC 15938-5 [2] for a detailed |
| | specification). |
| CreationCoordinates | Describes the location(s) and date(s) of creation of the |
| | programme (optional). |
| DepictedCoordinates | Describes the location(s) and date(s) depicted in the |
| | programme (optional). |
| ReleaseInformation | Information about the country and date of release of a |
| | programme. |
| Duration | Indicates the approximate duration of the programme. |
| PurchaseList | A list of purchase items. |

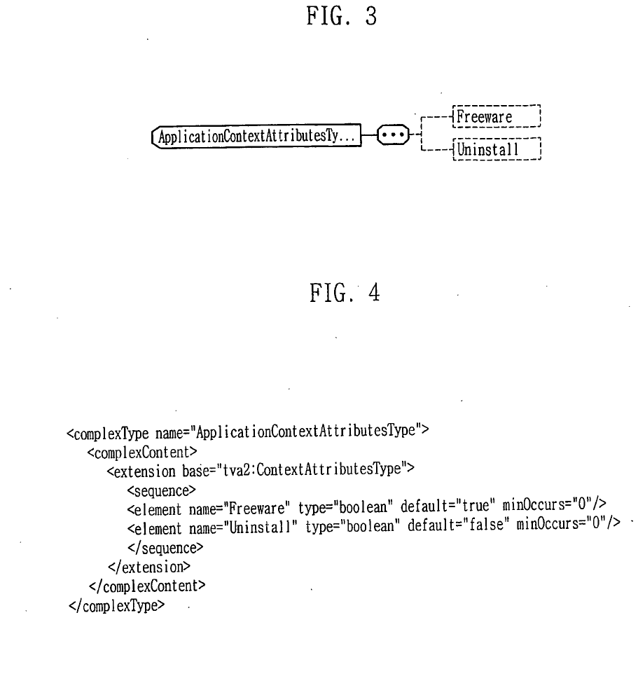

FIG. 3 is a schema on detailed information of an application in accordance with an embodiment of the present invention and FIG. 4 is an XML schema defining a schema structure shown in FIG. 3.

Referring to FIG. 3, ApplicationContextAttributesTypedescription is metadata description means on detailed information of an application.

A function definition of each element on detailed information of an application is as the following Table 3.

TABLE 3

| Name | Definition |
|---|---|
| ApplicationContextAttributesType | A complex type that defines a set of elements that describes |
| | characteristics of application content. |
| Freeware | The value of this field is true/false. If true, the application is free |
| Uninstall | This field indicates whether the application provides uninstall |
| | functionality. |

B. Category Description Metadata

Application category classification scheme (CS) and operating system category CS in the Table 3 will be described hereinafter.

The above application category CS can be received from a software category provider. For example, the application category can be received from the CNET Networks Ins. (www.centnetworks.com) providing a software category and a Korea Software Industry Association (http://www.softwarecatalog.co.kr).

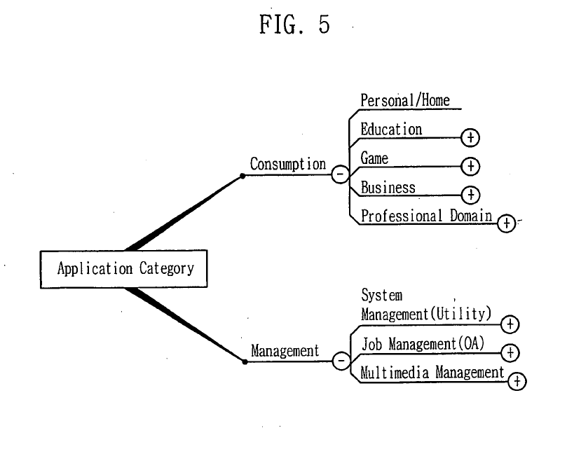

FIG. 5 is a diagram showing a high-level structure of an application program in accordance with an embodiment of the present invention.

A high-level of “application category” CS is divided into Consumption and Management according to usage object of the application referring to FIG. 5.

Applications included in the Consumption includes applications for simple consumption of users and applications included in the Management includes applications for management of user systems.

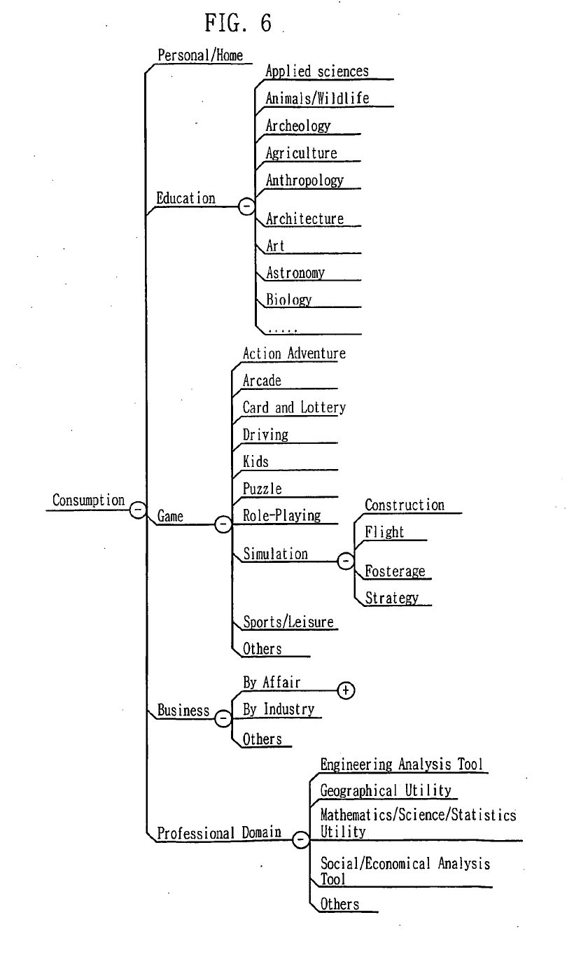

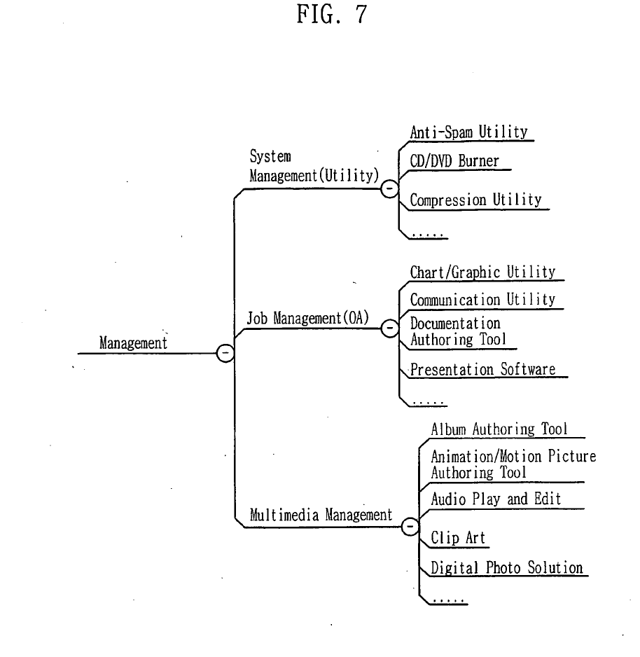

FIG. 6 is an exemplary diagram showing a category structure of the Consumption shown in FIG. 5, and FIG. 7 is an exemplary diagram showing a category structure of the Management shown in FIG. 5.

An application category for the Consumption includes Personal/Home, Education, Game, Business and Professional Domain, as shown in FIG. 6.

An application category for the Management includes System Management, Job Management, Multimedia Management as shown in FIG. 7.

Metadata of the application category further includes Audio/Video, Internet, Enterprise Computing, Design and Photo, Utility and Data Broadcasting. One embodiment of an XML metadata format of the application category CS is as Appendix 1 attached in an end of the detailed description.

For example, an operating system category can be organized as the following Table 4.

TABLE 4

| Category 1 | Category 2 |
|---|---|
| DOS | |
| Windows | Windows 3.X |
| | Windows 95 |
| | Windows 98 |
| | Windows Me |
| | Windows NT |
| | Windows 2000 |
| | Windows 2003 Server |
| | Windows XP |
| Linux | |
| Unix | |
| Solaris | |
| OS2 | |
| Mac | System 6 |
| | System 7 |
| | Mac OS 7.x |
| | Mac OS 8.x |
| | Mac OS 9.x |
| | Mac OS X |
| | Mac OS X Server |
| Mobile | Palm OS 1.x |
| | Palm OS 2.x |
| | Palm OS 3.x |
| | Palm OS 4.x |
| | Palm OS 5.x |
| | Windows CE 1.x |
| | Windows CE 2.x |
| | Pocket PC |
| | Pocket PC 2002 |
| | Pocket PC 2003 |
| | Celvic OS |

One embodiment of an XML metadata format of the application category CS is as Appendix 2 attached in an end of the detailed description.

C. Extended UED Metadata

The extended UED metadata suggested in the present invention are metadata additionally required for supporting application program download in diverse terminals. Exact model type and/or version information of a set-top box are important to determine whether an application program provided in the set-top box supporting a TV-Anytime service is exactly operated. For example, patch application of a Utility category is used to update a firmware or Operating System (OS), and herein, the extended UED metadata should include a producer information, model and version information of a set-top box.

In addition, CPU performance, memory capacity, support OS, a kind of middleware, a kind of virtual machines and other system software will be described to describe a systemic characteristic of a terminal which can be operated by an application program.

Also, storage capacity of a storing device or a type of diverse terminals can be described.

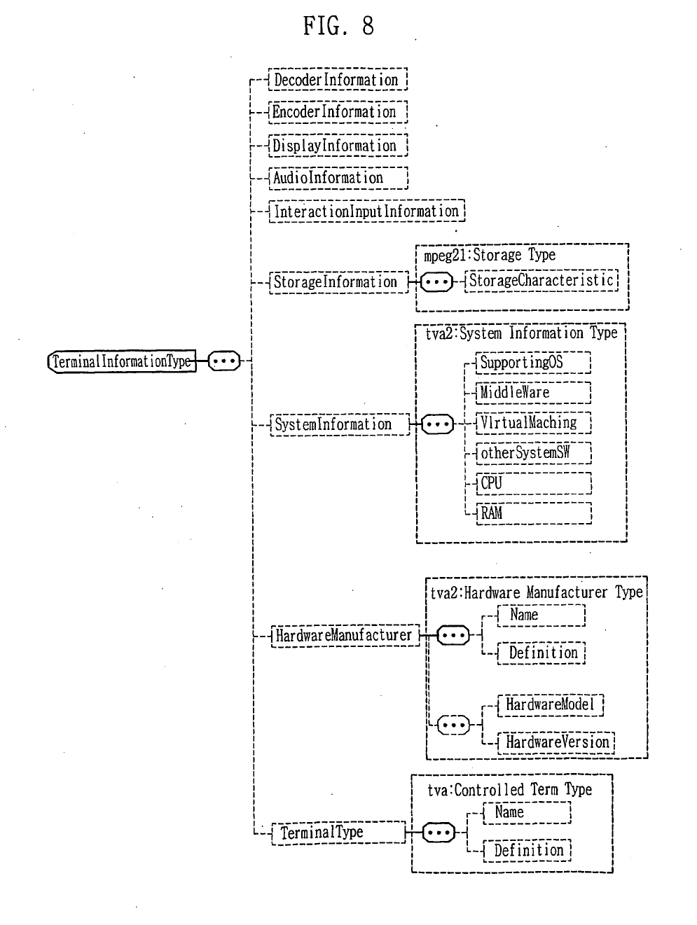

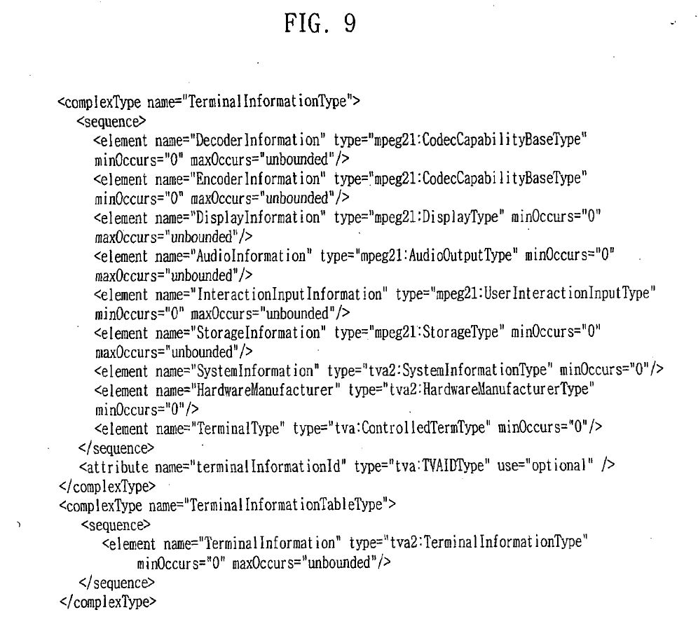

FIG. 8 is a schema showing one example of extended UED means in accordance with an embodiment of the present invention and FIG. 9 is an XML schema defining a schema structure shown in FIG. 8.

As shown in FIGS. 8 and 9, metadata describing on a terminal among usage environment are extended by adding hardware producer information including a hardware model and version information.

In addition, CPU performance, memory capacity, support Operating System (OS), a kind of middleware, a kind of virtual machines, other system SW information are added to describe a systemic characteristic of a terminal which can be operated by an application program.

Also, storage capacity of a storing device and type information of diverse terminals are added.

Each element included in an extended UED means for exactly supporting an application program download following an embodiment of the present invention is as the following Table 5.

TABLE 5

| Name | Definition |
|---|---|
| VersionType | A simple type that defines a version of the object. |
| CPUType | A complex type that describes the properties of the processor |
| clockSpeed | Describes the clock speed of the CPU. |
| unit | Defines the unit used to describe the CPU clock speed. |
| RAMType | A complex type that describes the properties of the Random |
| | Access Memory being used within the terminal |
| size | Describes the size of the RAM. |
| unit | Defines the unit used to describe the RAM size. |
| SystemInformationType | A complex type that describe the properties of the overall |
| | system |
| SupportingOS | Describes the OS used in the terminal. |
| Middleware | Describes the middlewares running in the terminal. |
| VirtualMachine | Describes the virtual machines running in the terminal. |
| OtherSystemSW | Describes System softwares running in the terminal other than |
| | middlewares and virtual machines. |
| CPU | Describes the CPU of the terminal. See Annex A for the |
| | classification scheme of the CPU names. |
| RAM | Describes the RAM of the terminal |
| HardwareManufacturerType | A complex type that describes the properties of the hardware |
| HardwareModel | Describes the terminal device model depending on a specific |
| | manufacturer. |
| HardwareVersion | Describes the version of embedded operating system in a |
| | terminal device. |
| TerminalInformationType | Describes the capability of a single terminal device. |
| DecoderInformation | Describes the decoding capability of the terminal. See |
| | ISO/IEC 21000-7 Section 6.5.4 [19]. |
| EncoderInformation | Describes the encoding capability of the terminal. See ISO/IEC |
| | 21000-7 Section 6.5.4 [19]. |
| DisplayInformation | Tool for describing the capability of displays. See ISO/IEC |
| | 21000-7 Section 6.5.8 [19]. |
| AudioInformation | Describes the audio presentation capability of the terminal. See |
| | ISO/IEC 21000-7 Section 6.5.12 [19]. Note that the audio |
| | capabilities regarding codes are described in |
| | DecoderInformation and/or EncoderInformation. |
| InteractionInputInformation | Describes the User interaction input support of the terminal. |
| | See ISO/IEC 210900-7 Section 6.5.14. |
| StorageInformation | Describes the characteristics of the storage unit. See ISO/IEC |
| | 21000-7 Section 6.5.18 [19]. |
| SystemInformation | Describes the system information of the terminal. |
| RAM | Describes the RAM of the terminal. |
| HardwareManufacturer | Indicates manufacturer of the hardware. |
| TerminalType | Describes the terminal type based on the types of device such |
| | as PC, PDA and so on. See appendix xx for the classification |
| | scheme of the terminal types. |
| terminalInformationId | An attribute that uniquely identifies the terminal information. |
| TerminalInformationTableType | A complex type that describes a table of the capability of |
| | terminal device. |
| TerminalInformation | A list of the capability of terminal information records for a |
| | single terminal. |

The metadata of the application program described above and extended UED metadata for supporting a download of the application program are provided to a user terminal by being included in a package generated in a server providing TV-Anytime service. When the package is provided through a two-way network such as Internet and simultaneously includes an application for data broadcasting, it is required to exactly discern a middleware type, which is a box type, for data broadcasting of a user terminal to select a proper application according to the middleware type for data broadcasting, which is a box type, such as Multimedia Home Platform (MHP), Application Configuration Access Protocol (ACAP) and Airborne Radio Interface Processor (ARIP), supported in a user terminal. It is desirable to include Middleware information in a form of SystemInformation of TerminalInformation described above, just as the following Table 6.

```
TABLE 6
<complexType name=“SystemInformationType”>
  <sequence minOccurs=“0” maxOccurs=“unbounded”>
  <element  name=“SupportingOS”  type=“tva:ControlledTermType”
minOccurs=“0”/>
  <element  name=“MiddleWare”  type=“tva:ControlledTermType” minOccurs=“0”
maxOccurs=“unbounded”/>
  <element  name=“VirtualMachine”  type=“tva:ControlledTermType”
minOccurs=“0” maxOccurs=“unbounded”/>
  <element  name=“OtherSystemSW”  type=“tva:ControlledTermType”
minOccurs=“0” maxOccurs=“unbounded”/>
    <element name=“CPU” type=“tva2:CPUType” minOccurs=“0”/>
    <element name=“RAM” type=“tva2:RAMType” minOccurs=“0”/>
  </sequence>
</complexType>
```

<A System and a Method for an Application Program Downloading System and a Method>

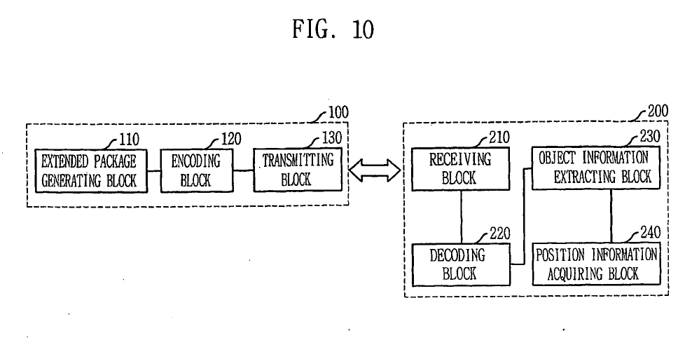

FIG. 10 is a block diagram showing a structure of an application program service system in accordance with an embodiment of the present invention.

As shown in FIG. 10, an entire system comprises an extended package providing means 100 for providing an extended package including metadata on usage environment and general and detailed information on the application to a user terminal, and a user terminal 200 consuming and using the predetermined application program which fits to a usage environment of a user terminal by using the extended package. Herein, the extended package providing means comprises an extended package generating block 110 for generating the extended package including an identifier of an object corresponding to the application program, an encoding block 120 for encoding the extended package, and a transmitting block 130 for transmitting the encoded package to the user terminal. The identifier uses Content Reference Identifier (CRID) defined in a TV-Anytime standard and the user terminal 200 can acquire local information of an object by using the CRID corresponding to each object information. The user terminal 200 comprises a receiving block 210, a decoding block 220, an object information extracting block 230 and a position information acquiring block 240. The receiving block 210 receives an extended package with respect to an application program to acquire. The decoding block 220 decodes an encoded extended package. The object information extracting block 230 extracts object information of the application program from the decoded extended package. The position information acquiring block 240 acquires position information of an application program by using the object information. A micro processor of the user terminal 200 can acquire the corresponding application program by using the position information of the object.

The method for an application program download service following the embodiment of the present invention includes the steps of producing an application program by a service provider, forming an extended package including metadata for supporting download of the produced application program, transmitting the extended package to a user terminal by a service provider and acquiring the application program, which fits to a user terminal environment, by using the extended package. Herein, as described above, in the steps that the user terminal acquires the application program, a desirable application program is acquired by extracting an object information identifier of the application program from the received extended package and acquiring position information of the desirable object by using the object information identifier. Also, the identifier is the CRID defined in a TV-Anytime standard.

For example, when an application program is related to a French learning and OS is a window CE, an application description metadata is as the following Table 7.

TABLE 7

```
  <Selection select_id=“WINCEPlayer”>
    <Descriptor>
      <ObjectDescription>
        <ContentDescription>
          <tva:Title>AudioPlayer for WinCE </tva:Title>
          <ContentProperties>
            <ContextAttributes
            xsi:type=“ApplicationContextAttributesType”>
              <Freeware>true</Freeware>
            </ContextAttributes>
          </ContentProperties>
          <TargetingInformation>
            <TerminalInformation>
              <SystemInformation>
                <SupportingOS
href=“urn:tva:metadata:Phase2:cs:OperatingSystemCS:2005:9.1”>
                  <tva:Name>Windows CE</tva:Name>
                </SupportingOS>
              </SystemInformation>
            </TerminalInformation>
          </TargetingInformation>
        </ContentDescription>
      </ObjectDescription>
    </Descriptor>
  </Selection>
```

The present invention can be used in a download service of an application program in a TV-Anytime service by providing an application metadata structure which enables an application program to be properly consumed or used in a terminal according to a usage object.

While the present invention has been described with respect to certain preferred embodiments, it will be apparent to those skilled in the art that various changes and modifications may be made without departing from the scope of the invention as defined in the following claims.

APPENDIX 2
XML Metadata of Operating System Category CS

```
<?xml version=“1.0” encoding=“UTF-8”?>
<ClassificationScheme
uri=“urn:tva:metadata:Phase2:cs:OperatingSystemCS:2005”>
<!--#################################################### -->
<!-- OPERATING SYSTEM
-->
<!-- Definition: This is a set of terms used within Content -->
<!-- Packaging to indicate what kind of operating system is proper-->
<!-- to operate an application program
-->
<!-- #################################################### -->
<Term termID=“1”>
        <Name xml:lang=“en”>DOS</Name>
    </Term>
    <Term termID=“2”>
        <Name xml:lang=“en”>Windows</Name>
        <Term termID=“2.1”>
            <Name xml:lang=“en”>Windows 3.X</Name>
        </Term>
        <Term termID=“2.2”>
            <Name xml:lang=“en”>Windows 95</Name>
        </Term>
        <Term termID=“2.3”>
            <Name xml:lang=“en”>Windows 98</Name>
        </Term>
        <Term termID=“2.4”>
            <Name xml:lang=“en”>Windows Me</Name>
        </Term>
        <Term termID=“2.5”>
            <Name xml:lang=“en”>Windows NT</Name>
        </Term>
        <Term termID=“2.6”>
            <Name xml:lang=“en”>Windows 2000</Name>
        </Term>
        <Term termID=“2.7”>
            <Name xml:lang=“en”>Windows 2003 Server</Name>
        </Term>
        <Term termID=“2.8”>
            <Name xml:lang=“en”>Windows XP</Name>
        </Term>
    </Term>
    <Term termID=“3”>
        <Name xml:lang=“en”>Linux</Name>
    </Term>
    <Term termID=“4”>
        <Name xml:lang=“en”>Unix</Name>
    </Term>
    <Term termID=“5”>
        <Name xml:lang=“en”>Solaris</Name>
    </Term>
    <Term termID=“6”>
        <Name xml:lang=“en”>OS2</Name>
    </Term>
    <Term termID=“7”>
        <Name xml:lang=“en”>Mac</Name>
        <Term termID=“7.1”>
            <Name xml:lang=“en”>System 6</Name>
        </Term>
        <Term termID=“7.2”>
            <Name xml:lang=“en”>System 7</Name>
        </Term>
        <Term termID=“7.3”>
            <Name xml:lang=“en”>Mac OS 7.x</Name>
        </Term>
        <Term termID=“7.4”>
            <Name xml:lang=“en”>Mac OS 8.x</Name>
        </Term>
        <Term termID=“7.5”>
            <Name xml:lang=“en”>Mac OS 9.x</Name>
        </Term>
        <Term termID=“7.6”>
            <Name xml:lang=“en”>Mac OS X</Name>
        </Term>
        <Term termID=“7.7”>
            <Name xml:lang=“en”>Mac OS X Server</Name>
        </Term>
    </Term>
    <Term termID=“8”>
        <Name xml:lang=“en”>Mobile</Name>
        <Term termID=“8.1”>
            <Name xml:lang=“en”>Palm OS 1.x</Name>
        </Term>
        <Term termID=“8.2”>
            <Name xml:lang=“en”>Palm OS 2.x</Name>
        </Term>
        <Term termID=“8.3”>
            <Name xml:lang=“en”>Palm OS 3.x</Name>
        </Term>
        <Term termID=“8.4”>
            <Name xml:lang=“en”>Palm OS 4.x</Name>
        </Term>
        <Term termID=“8.5”>
            <Name xml:lang=“en”>Palm OS 5.x</Name>
        </Term>
        <Term termID=“8.6”>
            <Name xml:lang=“en”>Windows CE 1.x</Name>
        </Term>
        <Term termID=“8.7”>
            <Name xml:lang=“en”>Windows CE 2.x</Name>
        </Term>
        <Term termID=“8.8”>
            <Name xml:lang=“en”>Pocket PC</Name>
        </Term>
        <Term termID=“8.9”>
            <Name xml:lang=“en”>Pocket PC 2002</Name>
        </Term>
        <Term termID=“8.10”>
            <Name xml:lang=“en”>Pocket PC 2003</Name>
        </Term>
        <Term termID=“8.11”>
            <Name xml:lang=“en”>Celvic OS</Name>
        </Term>
        <Term termID=“8.12”>
            <Name xml:lang=“en”>EPOC (Psion OS)</Name>
        </Term>
        <Term termID=“8.13”>
            <Name xml:lang=“en”>Symbian</Name>
        </Term>
        <Term termID=“8.14”>
            <Name xml:lang=“en”>Windows Mobile 2003 Phone
Edition</Name>
        </Term>
    </Term>
    <Term termID=“9”>
        <Name xml:lang=“en”>Embedded OS</Name>
        <Term termID=“9.1”>
            <Name xml:lang=“en”>Windows CE</Name>
        </Term>
        <Term termID=“9.2”>
            <Name xml:lang=“en”>Embedded Linux </Name>
        </Term>
        <Term termID=“9.3”>
            <Name xml:lang=“en”>Embedded Java</Name>
        </Term>
    </Term>
    <Term termID=“10”>
        <Name xml:lang=“en”>RTOS (Real Time OS)</Name>
        <Term termID=“10.1”>
            <Name xml:lang=“en”>pSOS</Name>
        </Term>
        <Term termID=“10.2”>
            <Name xml:lang=“en”>OS-9</Name>
        </Term>
        <Term termID=“10.3”>
            <Name xml:lang=“en”>VxWorks</Name>
        </Term>
        <Term termID=“10.4”>
            <Name xml:lang=“en”>QNX</Name>
        </Term>
        <Term termID=“10.5”>
            <Name xml:lang=“en”>VRTX</Name>
        </Term>
        <Term termID=“10.6”>
            <Name xml:lang=“en”>Nucleus</Name>
        </Term>
        <Term termID=“10.7”>
            <Name xml:lang=“en”>Qplus</Name>
        </Term>
        <Term termID=“10.8”>
            <Name xml:lang=“en”>Lynx</Name>
        </Term>
        <Term termID=“10.9”>
            <Name xml:lang=“en”>RT-Linux</Name>
        </Term>
    </Term>
    </ClassificationScheme>
```

1-24. (canceled)

25. A method for servicing an application program, comprising the steps of:
generating a metadata including general information and detailed information of the application program and usage environment information of a terminal to which the application program is applied; and
transmitting the metadata to the terminal.

26. The method as recited in claim 25, wherein the general information includes a description for common characteristics of contents objects and the description includes at least one information among a title, a media title, a short title, a synopsis, recommendation information, a keyword, a genre, parental guidance, a language, an actor, an award, related contents, a production date, a production location and a producer.

27. The method as recited in claim 25, wherein the detailed information includes a description for characteristics of the application program and the description includes at least one information among whether the application program is charged or free, and whether a deletion program is provided.

28. The method as recited in claim 25, wherein the usage environment information includes at least one information among a hardware manufacturer, a hardware version, a hardware model, Central Processing Unit (CPU) performance, memory capacity, support operating system (OS), a kind of middleware, a kind of virtual machines, other system software (SW), storage capacity of a storing device, and a type of the terminal to which the application program is applied.

29. The method as recited in claim 25, wherein the metadata includes identification information for identifying the application program.

30. The method as recited in claim 28, wherein the support operating system (OS) information is classified into version or type of operating system (OS) of the terminal to which the application program is applied.

31. An apparatus for servicing an application program, comprising:
a generating unit for generating a metadata including general information and detailed information of the application program and usage environment information of a terminal to which the application program is applied; and
a transmitting unit for transmitting the metadata to the terminal.

32. The apparatus as recited in claim 31, wherein the general information includes a description for common characteristics of contents objects and the description includes at least one information among a title, a media title, a short title, a synopsis, recommendation information, a keyword, a genre, parental guidance, a language, an actor, an award, related contents, a production date, a production location and a producer.

33. The apparatus as recited in claim 31, wherein the detailed information includes a description for characteristics of the application program and the description includes at least one information among whether the application program is charged or free, and whether a deletion program is provided.

34. The apparatus as recited in claim 31, wherein the usage environment information includes at least one information among a hardware manufacturer, a hardware version, a hardware model, Central Processing Unit (CPU) performance, memory capacity, support operating system (OS), a kind of middleware, a kind of virtual machines, other system software (SW), storage capacity of a storing device, and a type of the terminal to which the application program is applied.

35. The apparatus as recited in claim 34, wherein the metadata includes identification information for identifying the application program.

36. The method as recited in claim 28, wherein the support operating system (OS) information is classified into version or type of operating system (OS) of the terminal to which the application program is applied.

37. A method for acquiring an application program, comprising the steps of:
receiving a metadata including general information and detailed information of the application program and usage environment information of a terminal to which the application program is applied; and
acquiring the application program which fits to the usage environment information of the terminal by using the metadata.

38. The method as recited in claim 37, wherein the general information includes a description for common characteristics of contents objects and the description includes at least one information among a title, a media title, a short title, a synopsis, recommendation information, a keyword, a genre, parental guidance, a language, an actor, an award, related contents, a production date, a production location and a producer.

39. The method as recited in claim 37, wherein the detailed information includes a description for characteristics of the application program and the description includes at least one information among whether the application program is charged or free, and whether a deletion program is provided.

40. The method as recited in claim 37, wherein the usage environment information includes at least one information among a hardware manufacturer, a hardware version, a hardware model, Central Processing Unit (CPU) performance, memory capacity, support operating system (OS), a kind of middleware, a kind of virtual machines, other system software (SW), storage capacity of a storing device, and a type of the terminal to which the application program is applied.

41. The method as recited in claim 37, wherein the metadata includes identification information for identifying the application program.

42. The method as recited in claim 40, wherein the support operating system (OS) information is classified into version or type of operating system (OS) of the terminal to which the application program is applied.

43. A terminal for acquiring an application program, comprising:
a receiving unit for receiving a metadata including general information and detailed information of the application program and usage environment information of a terminal to which the application program is applied; and
an acquiring unit for acquiring the application program which fits to the usage environment information of the terminal by using the metadata.

44. The terminal as recited in claim 43, wherein the general information includes a description for common characteristics of contents objects and the description includes at least one information among a title, a media title, a short title, a synopsis, recommendation information, a keyword, a genre, parental guidance, a language, an actor, an award, related contents, a production date, a production location and a producer.

45. The terminal as recited in claim 43, wherein the detailed information includes a description for characteristics of the application program and the description includes at least one information among whether the application program is charged or free, and whether a deletion program is provided.

46. The terminal as recited in claim 43, wherein the usage environment information includes at least one information among a hardware manufacturer, a hardware version, a hardware model, Central Processing Unit (CPU) performance, memory capacity, support operating system (OS), a kind of middleware, a kind of virtual machines, other system software (SW), storage capacity of a storing device, and a type of the terminal to which the application program is applied.

47. The terminal as recited in claim 43, wherein the metadata includes identification information for identifying the application program.

48. The terminal as recited in claim 46, wherein the support operating system (OS) information is classified into version or type of operating system (OS) of the terminal to which the application program is applied.

49. A computer readable medium recorded a metadata, the metadata comprising:
general information and detailed information of an application program; and
usage environment information of a terminal to which the application program is applied.

50. The computer readable medium as recited in claim 49, wherein the general information includes a description for common characteristics of contents objects and the description includes at least one information among a title, a media title, a short title, a synopsis, recommendation information, a keyword, a genre, parental guidance, a language, an actor, an award, related contents, a production date, a production location and a producer.

51. The computer readable medium as recited in claim 49, wherein the detailed information includes a description for characteristics of the application program and the description includes at least one information among whether the application program is charged or free, and whether a deletion program is provided.

52. The computer readable medium as recited in claim 49, wherein the usage environment information includes at least one information among a hardware manufacturer, a hardware version, a hardware model, Central Processing Unit (CPU) performance, memory capacity, support operating system (OS), a kind of middleware, a kind of virtual machines, other system software (SW), storage capacity of a storing device, and a type of the terminal to which the application program is applied.

53. The computer readable medium as recited in claim 49, wherein the metadata includes identification information for identifying the application program.

54. The computer readable medium as recited in claim 52, wherein the support operating system (OS) information is classified into version or type of operating system (OS) of the terminal to which the application program is applied.
